(19) United States
(12) Patent Application Publication
(10) Pub. No.: US 2010/0085898 A1
(43) Pub. Date: Apr. 8, 2010

(54) METHODS FOR DETECTING ROUTING LOOPS BETWEEN HOME AGENTS

(75) Inventors: Gerardo Giaretta, San Diego, CA (US); Georgios Tsirtsis, London (GB); Arungundram C. Mahendran, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/565,248

(22) Filed: Sep. 23, 2009

Related U.S. Application Data
(60) Provisional application No. 61/099,834, filed on Sep. 24, 2008.

(51) Int. Cl. H04L 12/28

(52) U.S. Cl. 370/255; 370/392; 370/310; 370/400

(57) ABSTRACT

Certain aspects of the present disclosure provide methods for detecting a routing loop between at least two home agents utilizing the mobile internet protocol (MIPv6) standard. In a first method, the home agent sends a test message to the last care of address associated with a mobile node and receives a reply if there is no loop. In a second method, the home agent parses a packet and checks if the address of any of the inner headers matches the address of the home agent to find a loop between home agents.

### RELATED APPLICATIONS

This application claims benefit of U.S. provisional patent Application Ser. No. 61/099,834 filed Sep. 24, 2008, and assigned to the assignee hereof and hereby expressly incorporated by reference herein.

### BACKGROUND

1. Field

Certain aspects of the present disclosure generally relate to wireless communication and, more particularly, to a technique for detecting routing loops between home agents in Mobile Internet Protocol version 6 (MIPv6).

2. Background

Mobile communications is an area of growing importance. Mobile IPv6 (MIPv6) protocol was developed as a subset of Internet Protocol version 6 (IPv6) to support mobile connections. Mobile IPv6 enables a mobile node (MN) to register its temporary location indicated by a care-of-address (CoA) to its Home Agent (HA). A home agent is a router on the same home network, which represents the mobile node while the mobile node is not attached with the home network. Care of Address (CoA) is the physical IP address of a MN while visiting a foreign network. The HA keeps a mapping (also called a binding) between the permanent address (also called Home Address (HoA)) and the registered CoA of the mobile node so that packets for the MN can be redirected to its current location using IP-encapsulation techniques (i.e., tunneling).

In MIPv6, a mobile node may create a routing loop between two home agents by registering the home address obtained by a first home agent with a second home agent and vice versa. If a routing loop exists between two or more home agents, every uplink and downlink packet originated by the mobile node or sent to the home address of the mobile node will remain in the loop, which adversely affects the resources of the home agents and the network.

Therefore, there is a need in the art for techniques to detect and eliminate the routing loops between home agents in MIPv6 to prevent performance degradation of the system because of the routing loops.

### SUMMARY

Certain aspects provide a method for wireless communications by a home agent. The method generally includes receiving a binding update message (BU) from a mobile node, sending a test message to the last Care-of-Address (CoA) registered by the mobile node, and receiving a reply from the mobile node in response to the test message, wherein the reply is received if there is no routing loop between the home agent and at least one other home agent.

Certain aspects provide a method for wireless communications by a home agent. The method generally includes intercepting a packet addressed to a home address (HoA), determining if the packet is previously tunneled, parsing a header of the packet to extract one or more source addresses of at least one inner header if the packet is previously tunneled, and tunneling the packet to a care of address associated with the home address if none of the one or more source addresses matches an address of the home agent.

Certain aspects provide an apparatus for wireless communications by a home agent. The apparatus generally includes logic for receiving a binding update message (BU) from a mobile node, logic for sending a test message to the last Care-of-Address (CoA) registered by the mobile node, and logic for receiving a reply from the mobile node in response to the test message, wherein the reply is received if there is no routing loop between the home agent and at least one other home agent.

Certain aspects provide an apparatus for wireless communications by a home agent. The apparatus generally includes logic for intercepting a packet addressed to a home address (HoA), logic for determining if the packet is previously tunneled, logic for parsing a header of the packet to extract one or more source addresses of at least one inner header if the packet is previously tunneled, and logic for tunneling the packet to a care of address associated with the home address if none of the one or more source addresses matches an address of the home agent.

Certain aspects provide an apparatus for wireless communications by a home agent. The apparatus generally includes means for receiving a binding update message (BU) from a mobile node, means for sending a test message to the last Care-of-Address (CoA) registered by the mobile node, and means for receiving a reply from the mobile node in response to the test message, wherein the reply is received if there is no routing loop between the home agent and at least one other home agent.

Certain aspects provide an apparatus for wireless communications by a home agent. The apparatus generally includes means for intercepting a packet addressed to a home address (HoA), means for determining if the packet is previously tunneled, means for parsing a header of the packet to extract one or more source addresses of at least one inner header if the packet is previously tunneled, and means for tunneling the packet to a care of address associated with the home address if none of the one or more source addresses matches an address of the home agent.

Certain aspects provide a computer-program product for wireless communications by a home agent, comprising a computer-readable medium having instructions stored thereon, the instructions being executable by one or more processors. The instructions generally include instructions for receiving a binding update message (BU) from a mobile node, instructions for sending a test message to the last Care-of-Address (CoA) registered by the mobile node, and instructions for receiving a reply from the mobile node in response to the test message, wherein the reply is received if there is no routing loop between the home agent and at least one other home agent.

Certain aspects provide a computer-program product for wireless communications by a home agent, comprising a computer-readable medium having instructions stored thereon, the instructions being executable by one or more processors. The instructions generally include instructions for intercepting a packet addressed to a home address (HoA), instructions for determining if the packet is previously tunneled, instructions for parsing a header of the packet to extract one or more source addresses of at least one inner header if the packet is previously tunneled, and instructions for tunneling the packet to a care of address associated with the home address if none of the one or more source addresses matches an address of the home agent.

Certain aspects of the present disclosure provide an apparatus for wireless communications by a home agent. The apparatus generally includes at least one processor configured to receive a binding update message (BU) from a mobile node, send a test message to the last Care-of-Address (CoA) registered by the mobile node, and receive a reply from the mobile node in response to the test message, wherein the reply is received if there is no routing loop between the home agent and at least one other home agent.

Certain aspects of the present disclosure provide an apparatus for wireless communications by a home agent. The apparatus generally includes at least one processor configured to intercept a packet addressed to a home address (HoA), determine if the packet is previously tunneled, parse a header of the packet to extract one or more source addresses of at least one inner header if the packet is previously tunneled, and tunnel the packet to a care of address associated with the home address if none of the one or more source addresses matches an address of the home agent.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an exemplary communication system in which the present disclosure may be used.

FIG. 2 is a block diagram of an exemplary router node that may be used in the communications system of FIG. 1.

FIG. 3 is a block diagram of an exemplary mobile node/correspondent node that may be used in the communications system of FIG. 1.

FIG. 4 illustrates example of an attack from a malicious mobile node that results in a routing loop between two home agents in MIPv6, in accordance with certain aspects of the present disclosure.

FIG. 5 illustrates a signaling technique for detecting a routing loop between home agents, in accordance with certain aspects of the present disclosure.

FIG. 6 illustrates example operations for a technique to detect a routing loop between home agents, in accordance with certain aspects of the present disclosure.

FIG. 6A illustrates example components capable of performing the operations illustrated in FIG. 6.

FIG. 7 illustrates example operations for an alternate technique to detect a routing loop between home agents, in accordance with certain aspects of the present disclosure.

FIG. 7A illustrates example components capable of performing the operations illustrated in FIG. 7.

### DETAILED DESCRIPTION

The RFC 3775 standard (i.e., Mobile Internet Protocol (MIPv6)) allows a mobile node to move from one link to another without changing its home address. Packets may be routed to the mobile node using the home address of the mobile node regardless of the current point of attachment of the mobile node to the Internet. The mobile node may also continue to communicate with other nodes (stationary or mobile) after moving to a new link. The movement of a mobile node away from its home link is thus transparent to transport and higher-layer protocols and applications.

Much of the terminology used in this document is well known and finds widespread usage in MIPv4/MIPv6 specifications and drafts. Various terms used in the present application will now be explained further so that they can be properly interpreted in the description which follows.

Mobile Node (MN): A host or router that can change its point of attachment from one network or sub-network to another. Mobile nodes may have some or all of the following attributes. A mobile node may change its location without changing its IP address, it may continue to communicate with other Internet nodes at any location using its (constant or persistent) IP address (known as the home address or HoA), assuming link-layer connectivity to a point of attachment is available.

In various aspects a mobile node is given a long-term (or persistent) (e.g., IP) address on a home network. This home address may be administered in the same way as a “permanent” IP address is provided to a stationary host. When away from its home network, a “care-of address (CoA)” is associated with the mobile node that is related to the mobile node's current point of attachment, called its location. The mobile node normally uses its home address as the source address of all IP datagrams that it sends, but must first reverse tunnel such packets from a foreign network to the Home Agent of the mobile, where the home address is topologically correct, so that ingress filtering will pass the packet.

A ‘Home Agent’ (HA) is a router on the home network, which represents the MN while it is not attached to the home network. The term ‘binding’ refers to the association of a home address with the care of address of a mobile node.

An ‘Access Node’ is a node that serves as a network attachment point for one or more mobile nodes. The access node may have wireless interfaces and support hand-off to enable a mobile node to rapidly and efficiently change Access Nodes.

A ‘Cell’ is the area of wireless coverage resulting from radio propagation and system limits that extends out from a radio antenna on an access node.

A ‘Session’ is a communication relationship that typically involves a bi-directional flow of packets between a mobile node and at least one correspondent node.

A ‘Session Peer’ is a peer with which a network node, e.g., a mobile node, has a negotiated session. Session peers can be mobile or stationary. The session peer is also called the correspondent node (CN) interchangeably.

A ‘Link’ is a facility or medium over which nodes can communicate at the link layer. A link underlies the network layer.

A ‘Link-Layer Address’ is an address used to identify an endpoint of some communication over a physical link. Typically, the Link-Layer address is an interface's Media Access Control (MAC) address.

A ‘Node’ is a network element that serves as a forwarding device. A router is an example of one type of node.

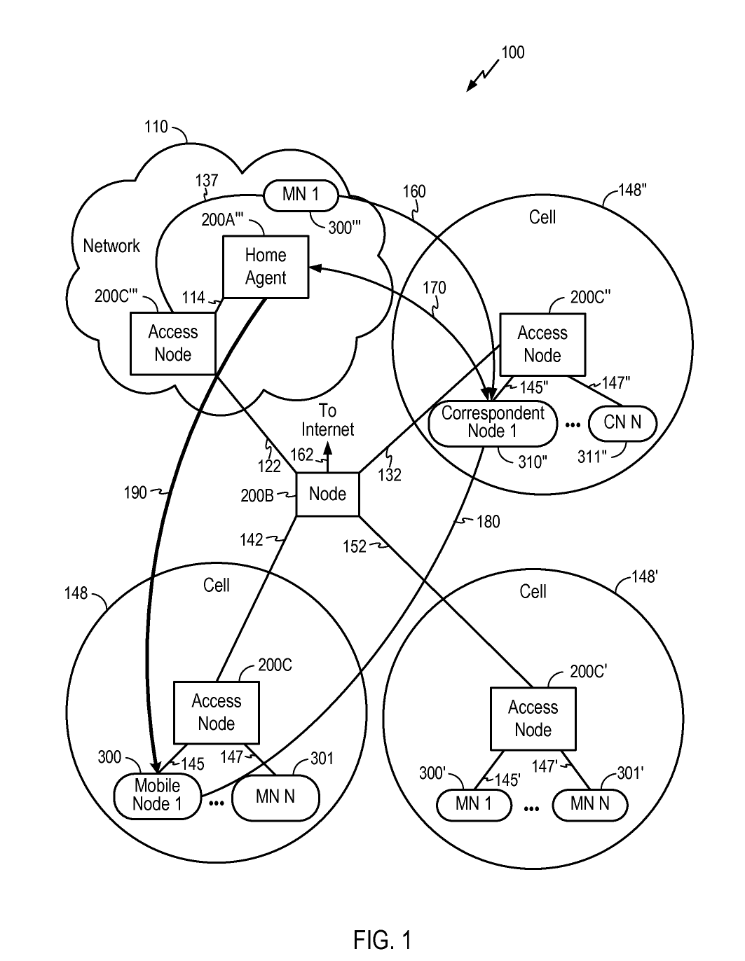

FIG. 1 illustrates an exemplary communications system 100 implemented in accordance with the methods and apparatus of the present disclosure. The system 100 includes first, second and third cells 148, 148′ and 148″ and a network 110. Cells 148, 148′, 148″ and network 110 are coupled to a router node 200B using links 142, 152, 132 and 122, respectively, where the B indicates that node 200B is a general router node. General router node 200B may also be coupled to, e.g., the Internet via link 162.

As shown, the cell 148 includes a node 200C, where the C indicates the node 200C is an access (router) node (i.e., a gateway), and a plurality of mobile nodes MN 1 300, MN N 301. The access node 200C manages mobile nodes (MNs) 300, 301 whilst in said cell 148, specifically providing bi-directional wireless communications links 145,147 between the access node and each mobile node MN1 300, MN N 301, respectively, as well as a bidirectional link 142 between access node 200C and the general router 200B.

The access node 200C also provides an address to the mobile nodes 300, 301 when in the cell 148 called the Care of Address (CoA). This CoA can be used as a source address by mobile nodes 300, 301 when in the foreign network of cell 148, and the access node 200C will allow this address to pass its ingress filtering check whereby the access node 200C ensures the source address is one of its addresses, and that CoA belongs to that specific MN.

Cellular networks are typically comprised of a multitude of such cells 148. In regard to FIG. 1, the second cell 148′ and the third cell 148″ are other cells which are the same as or similar to cell 148. Elements of the second cell 148′ and third cell 148″ are denoted using a′ and a″ respectively to distinguish them from like numbered elements of the first cell 148.

For example, access node 200C′ is in the second cell 148′. Note that correspondent node (CN) 310″ in cell 148″ is a stationary node for the purposes of this description although it is connected to access node 200C″ over a wireless link 145″ and therefore has a stable IP address.

The MN 1 300 in cell 148 is originally from the home network 110, and when MN 1 is located in its home network 110 which includes Home Agent 200A′″, MN 1 is labeled MN 1 300′″. The Home Agent (HA) 200A′″ and MN 300′″ are on a broadcast LAN within network 110 including links 137 and 114, which couples HA 200A′″ and MN 300′″ to the access node (AN) 200C′″.

The AN 200C′″ is coupled to the general router node 200B via link 122. The MN 300′″ has a home address allocated from the HA 200A′″ called the home address (HoA) which is a valid address at access node 200C′″ for ingress filtering purposes. This address is used as a source address by MN 300′″ when on its home network 110. The correspondent node (CN) 310″ in cell 148″ is the session peer of the MN 300′″ and hence the MN300′″ sends packets to the CN 310″ using the HoA of the MN 300′″ as a source address and the CN 310″ address as the destination address as shown by the packet flow 160.

Return packets from the CN 310″ to the MN 300′″ use the CN 310″ address as the source address and the HoA of MN 300′″ as the destination address which will be routed towards the Home Agent 200A′″ and the MN 300′″ as shown in packet flow 170. When the MN 300′″ is at home, the MN 300′″ receives the packet directly from the access node 200C′″ rather than having it forwarded by the HA 200A′″.

When the MN 300′″ moves away from its home network 110 to the foreign network 148, becoming MN 300, then the MN 300 gets a CoA from the access node 200C, which it registers into its HA 200A′″ as its location in a binding table. Packets from the CN 310″ to the MN 300 then again use flow 170 but now at the Home Agent 200A′″ they are encapsulated into a packet with the destination address equal to the currently registered CoA of the MN 300 and forwarded to the MN 300 on the foreign network in cell 148 as shown in flow 190.

Note that flows 170 and 190 are bidirectional in that the MN 300 also sends return packets to the CN 310″ using the HoA as the source address, via a reverse tunnel to the HA 200A′″ with the reverse tunnel including the source address of the MN 300 on the foreign link, this being the CoA. The HoA source address is hidden by the CoA so that the packet will pass the ingress filtering check in the access node 200C.

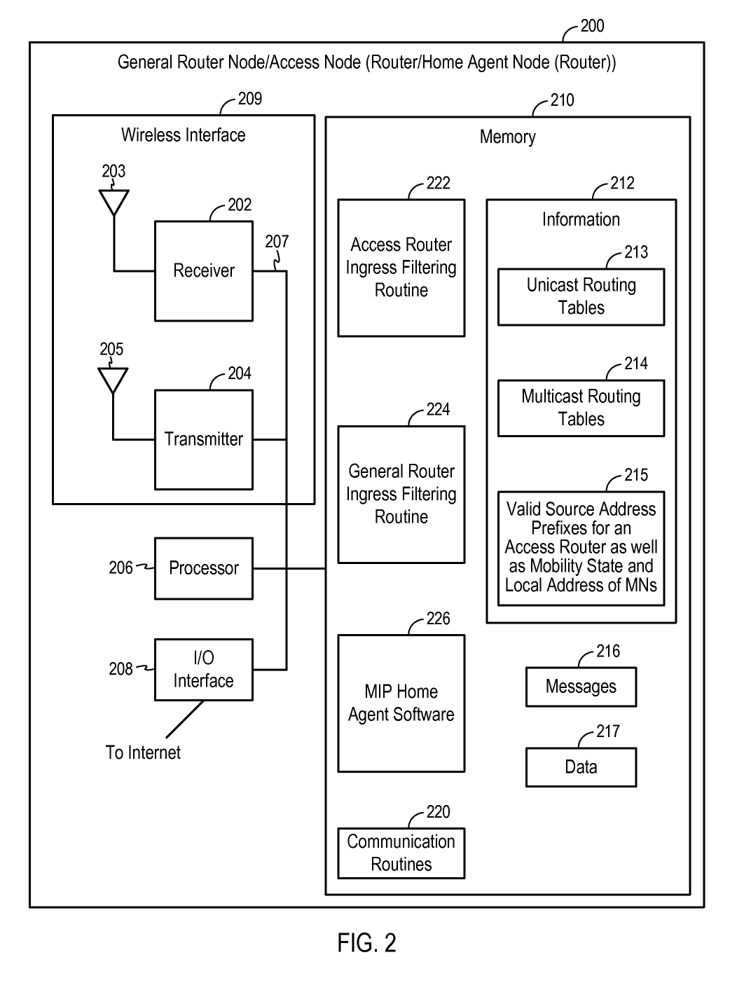

FIG. 2 is a block diagram of an exemplary general router node/access node/home agent node 200 that may be used in the communications system of FIG. 1 as e.g., node 200B, 200C, 200C′, 200C″, 200C′″, 200A′″.

As shown, the exemplary node 200 includes a processor 206, memory 210, a network interface 208, and may include wireless interface 209, coupled together by a bus 207 over which the various elements 206, 207, 208, 209 and 210 can interchange data and information. The network interface 208 is used to couple the node 200 to one or more network elements, e.g., other nodes 200 and/or the Internet.

In this manner, the node 200 may be a general router node 200B and can serve as a communications element between mobile nodes MN 300, 301 serviced by an access node 200C and other network elements. The access node 200C may be a wireless access router, which additionally includes wireless interface 209 including a receiver 202 and a transmitter 204. Receiver 202 is coupled to an antenna 203 for receiving signals from mobile nodes 300, 301. The transmitter 204 is coupled to a transmitter antenna 205 which can be used to broadcast signals to mobile nodes 300, 301.

Operation of the node (router) 200 is controlled by the processor 206 under direction of one or more routines stored in the memory 210. Memory 210 includes communications routines 220, data 217, access router ingress filtering routine 222, general router ingress filtering routine 224, Home Agent routine 226, messages such as packets 216, and information 212 that includes unicast routing/forwarding table 213, multicast routing/forwarding table 214 and active addressing state for the valid prefixes at an access router and the address allocations (HoAs and CoAs) made to or used by MNs 300, 301 at an access router 200C or a home agent 200A′″.

Tables 213, 214 are also known as binding tables. Communications routines 220 include various communications processes to support the reception, checking and forwarding of messages such as IP packets, for mobile nodes 300, 301 and correspondent nodes 310″, 311″. Data 217 includes data to be transmitted to, or received from, one or more mobile nodes 300, 301.

Data 217 may include policy state for the forwarding of packets from MNs 300, 301 such as whether ingress filtering is enabled, and the MN specific mobility policy in an access router 200C and a Home Agent 200A′″. Access router ingress filtering routine 222 polices the source addresses used by MNs 300, 301 into the network of cell 148 via the ingress interface. Each mobile node 300, 301 in the cell 148 serviced by the access router 200C may have any number of active communications sessions going on at any given time with CNs 310″, 311″.

Access Router ingress filtering routine 222 is ensuring that the MN 300 does not use the source address of another MN 301 in the cell 148, nor a source address that is invalid at this access router 200C due to it not being under the routing prefixes configured at that router 200C, such as from CN 310″. General router ingress filtering routine 224, used by, e.g., router 200B, is similarly used to police source addresses, but this time by comparing the incoming interface at which the packet arrived to the expected interface according to unicast and/or multicast routing tables 213, 214. Home Agent ingress filtering routines 226, used by, e.g., HA 200A′″, are responsible for controlling the mobility of the MNs 300, 301 and the forwarding to and from that MN 300, 301 when the MN 300, 301 is on a home network 110 or on foreign network, e.g., in cell 148.

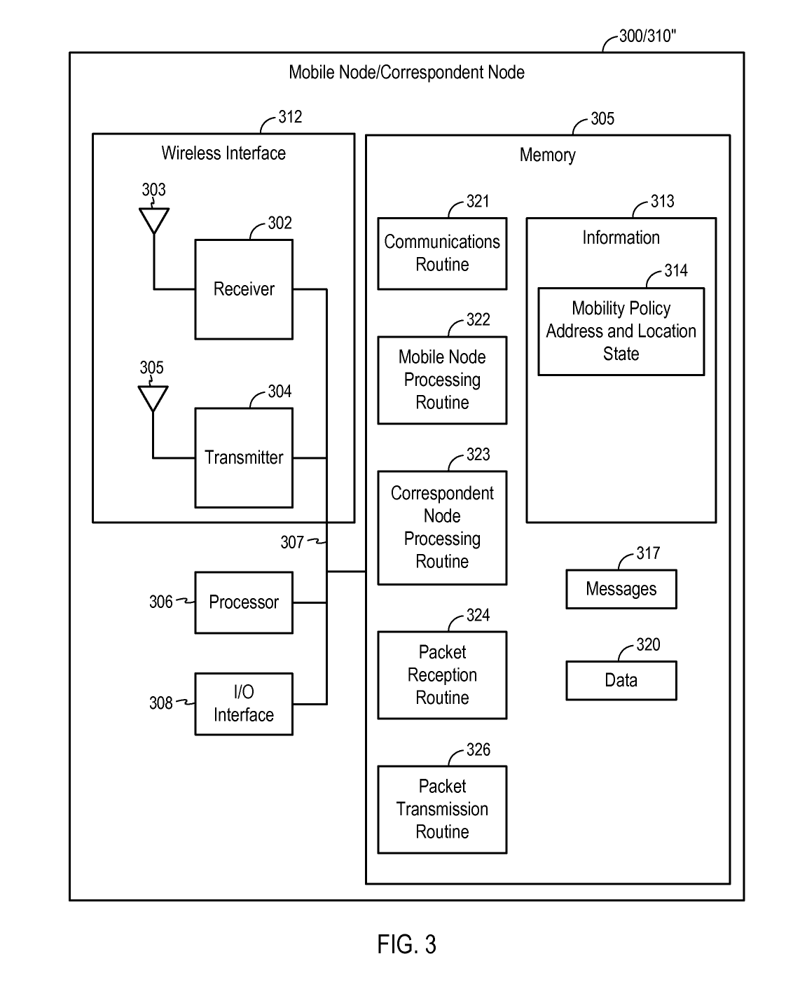

FIG. 3 is a block diagram of an exemplary mobile node (MN) 300 and/or Correspondent Node 310″ that may be used as one of the mobile nodes 300, 301, 300′, 301′, 300″ or correspondent nodes 310″/311″ in the various cells 148, 148′, 148″ and network 110 of the communications system shown in FIG. 1, in conjunction with the exemplary nodes 200 of FIG. 2.

The exemplary MN 300/CN 310″ includes processor 306, memory 305, and I/O interface 308 coupled together by a bus 307 over which the various elements 306, 305, and 308 can interchange data and information. I/O interface 308 may interconnect MN 300/CN 310″ to access routers 200C, 200C′, 200C″, 200C′″. If the MN 300 or CN 310″ is a wireless connected node then node 301/310″ also includes wireless node components 312, which include a receiver 302 and transmitter 304, coupled to bus 307.

The receiver 302 is coupled to an antenna 303 for receiving signals from one or more access nodes 200C, 200C′ etc. The transmitter 304 is coupled to a transmitter antenna 305 which can be used to broadcast signals to access nodes 200C, 200C′, 200C″, 200C′″. The mobile node 300 can interact with other mobile nodes 301, correspondent nodes 310″, 311″, and other network elements, e.g., HA 200A′″ by establishing communications sessions through an access router 200C, 200C′, 200C″, 200C′″.

Operation of the mobile node/correspondent node 300/310″ is controlled by the processor 306 under direction of one or more routines stored in the memory 305. Memory 305 includes communications routines 321, data 320, mobile node processing routine 322, correspondent node processing routine 323, packet reception routine 324, packet transmission routine 326, messages, e.g., packets 317 and information 313. Communications routines 323 include various communications applications which may be used to provide particular services, e.g., IP telephony, E-mail, video, games, etc., to a user of the mobile node/correspondent node 300/310″.

Data 320 includes data to be transmitted to, or received from an access node, e.g., access node 200C. Data 320 may include, e.g., voice data, E-mail packets, video images, game data, etc. Mobile node processing routine 322 is used to oversee various communications sessions which may be supported by the access router 200C and Home Agent router 200A′″ at any given time, to detect and to respond to various mobility and trigger events.

In response to a trigger event, such as receiving a particular message or detecting a hand-off, the mobile node processing routine 322 can control the mobile node 300 to transition a communications session between access routers whilst maintaining the HoA as a session address by updating the CoA in the Home Agent 200A′″. Similarly Correspondent Node 310″ includes a similar routine 322 if the CN 310″ is also mobile and has a subset of the routine 322, a correspondent node processing routine 323 if CN 310″ is fixed in the infrastructure for the session.

Each mobile node 300 may have any number of active communications sessions going on at any given time with any number and combination of mobile and fixed Correspondent Nodes 310″, 311″. Packet reception and transmission routines 324, 326 are used to receive and send packets as part of said sessions. The packet(s) are stored in memory 210, e.g., in the set of messages 216, prior transmission of the packets by transmitter 204.

The information 313 includes the mobility policy, location and address state information 314 distributed between the MN 300 and the access router 200C and the Home Agent 200A′″.

### Methods For Detecting Routing Loops Between Home Agents

The MIPv6 standard allows a mobile node to transparently maintain connections while moving from one subnet to another. Each mobile device is identified by its home address although it may be connecting to the internet through another network. When connecting through a foreign network, a mobile device sends its location information to a home agent, which intercepts packets intended for the device and tunnels them to the current location.

A mobile node may create a routing loop between two home agents by registering the home address obtained by a first HA with a second HA and vice versa. If a routing loop is created, every uplink and downlink packet originated by the mobile node or sent to the HoA of the mobile node will remain in the loop. This may adversely affect the resources of the HAs and the network.

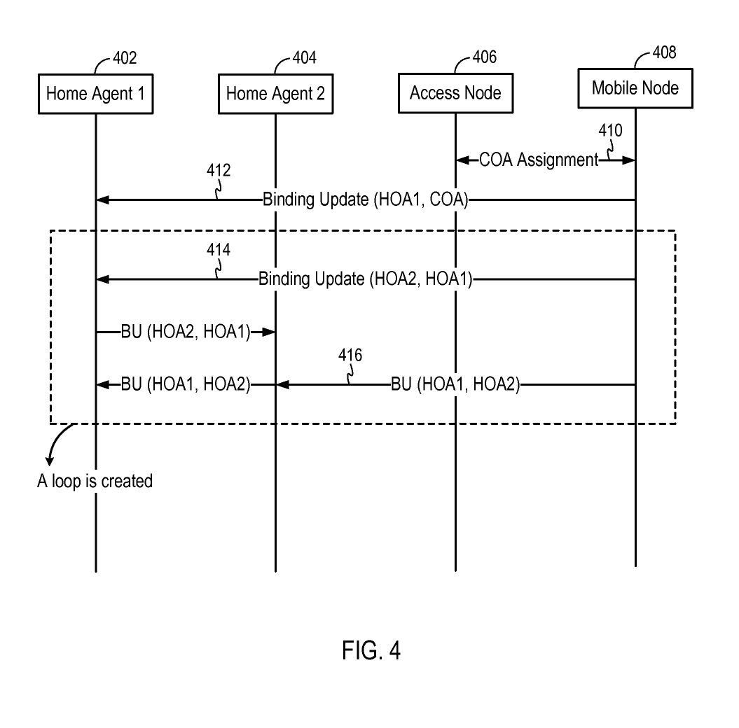

FIG. 4 illustrates an example of an attack from a malicious mobile node that results in a routing loop between two home agents in MIPv6, in accordance with certain aspects of the present disclosure.

A mobile node 408 may be connected through an access node (gateway) 406 with a home agent HA1 402. First, the mobile node performs a Care of Address assignment 410 with the access node 406. The mobile node may then send a binding update BU (HoA1, CoA) message 412 to the HA1. The mobile node may initiate an attack to the system by sending a second binding update BU (HoA2, HoA1) message 414 to the HA2 and registering the home address of the HA1 with the HA2 404. In addition, the mobile node may send a binding update BU (HoA1, HoA2) message 416 to the HA1 to register the home address of the HA2 with the HA1.

Therefore, following the above procedure, a loop may be created between two home agents. As a result, any downlink/uplink packet addressed to/sent by the mobile node may remain in the loop, which may adversely affect the performance and resources of the system.

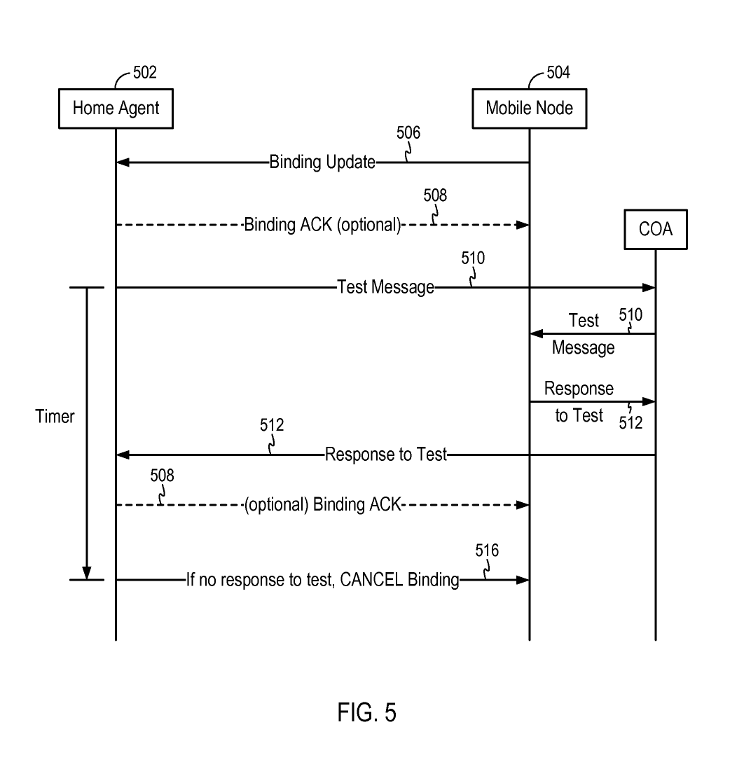

FIG. 5 illustrates a signaling technique for detecting a routing loop between two home agents, in accordance with certain aspects of the present disclosure. The home agent 502 may send a test message 510 to the last care of address registered by a mobile node 504 after receiving a binding update message 506 from the mobile node. If there is no loop between the home agent and other home agents, the care of address is valid and the mobile node receives the test message 510. Upon receiving the test message, the mobile node sends a reply message 512 to the home agent.

If there is a loop between the home agent and at least one other home agent, the message remains in the loop and does not reach the mobile node. As a result, the mobile node remains unaware of the test message and does not send a reply to the test message. The home agent may wait for a pre-set amount of time to receive a response from the mobile node. If the home agent does not receive a reply from the mobile node in the wait duration, the home agent may conclude that there is a loop between home agents. The home agent may then cancel the binding 516 to break the loop.

For certain aspects of the present disclosure, after receiving a binding update message from a mobile node, a home agent may immediately send a binding acknowledgement message 510 to the mobile node. For another aspect, the home agent may send an acknowledgement to the mobile node after verifying that there is no loop between home agents. One of the advantages of the former technique is that it does not introduce any delay in normal operation of the system. However, in the latter technique, even if there is no loop in the system, the home agent should wait until it receives a response to test message from the mobile node, which adds some delay in the normal operation of the system.

In MIPv6 standard, a correspondent node may send a Care of Address Test Initiation (CoTI) message to a mobile node to verify that the mobile node is in the position where it claims. Upon receiving the CoTI message, the mobile node replies with a Care-of Address Test (CoT) message. This procedure is called ‘return routability procedure’.

For certain aspects of the present disclosure, a home agent may perform a modified version of the return routability procedure to detect loops between home agents. The home agent may perform the Care-of Address Test Initiation (CoTI)/Care-of Address Test (CoT) test to detect the loop after receiving a binding update message from a mobile node. The CoTI/CoT messages may be similar to or different from the CoTI/CoT messages specified in MIPv6 standard for the correspondent nodes. It may be assumed that the validity of the binding update message is verified with checking mechanisms currently present in the MIPv6 standard.

For certain aspects of the present disclosure, the HA sends a CoTI message to the last care of address registered by the MN. If the MN replies with a CoT message, the CoA is valid and a loop is not created by the MN. If there is a loop, the MN will not receive a CoTI message, since the message remains in the loop. Therefore, the MN does not reply to the test message (i.e., CoT). The HA cancels the binding to break the loop if the HA does not receive a CoT message from the mobile node.

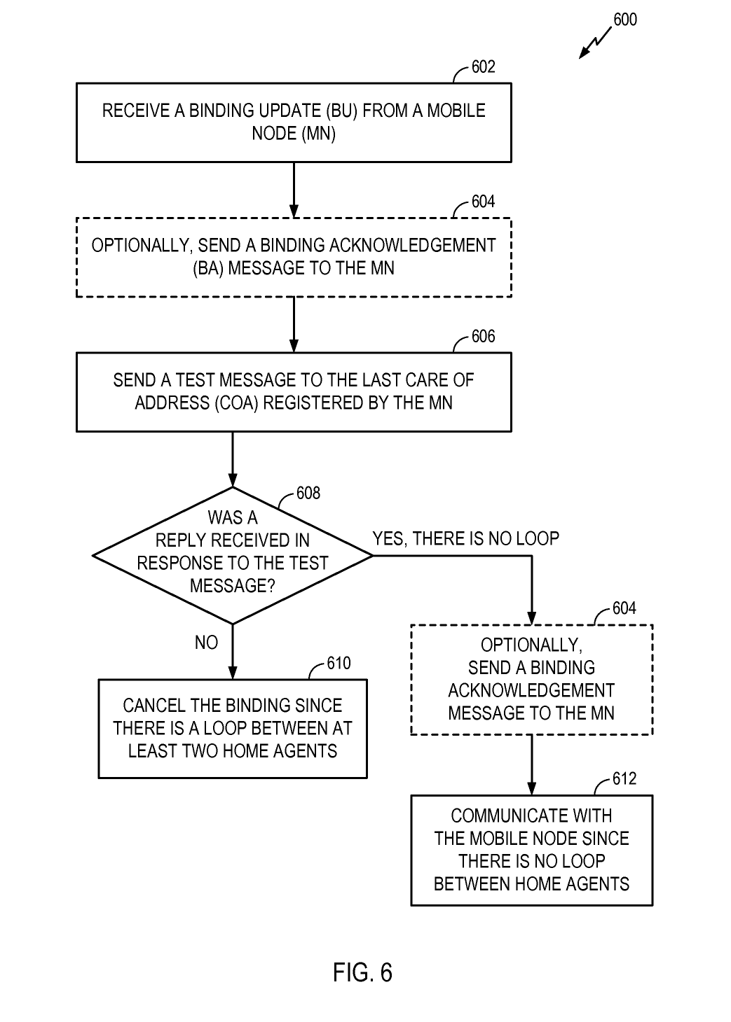

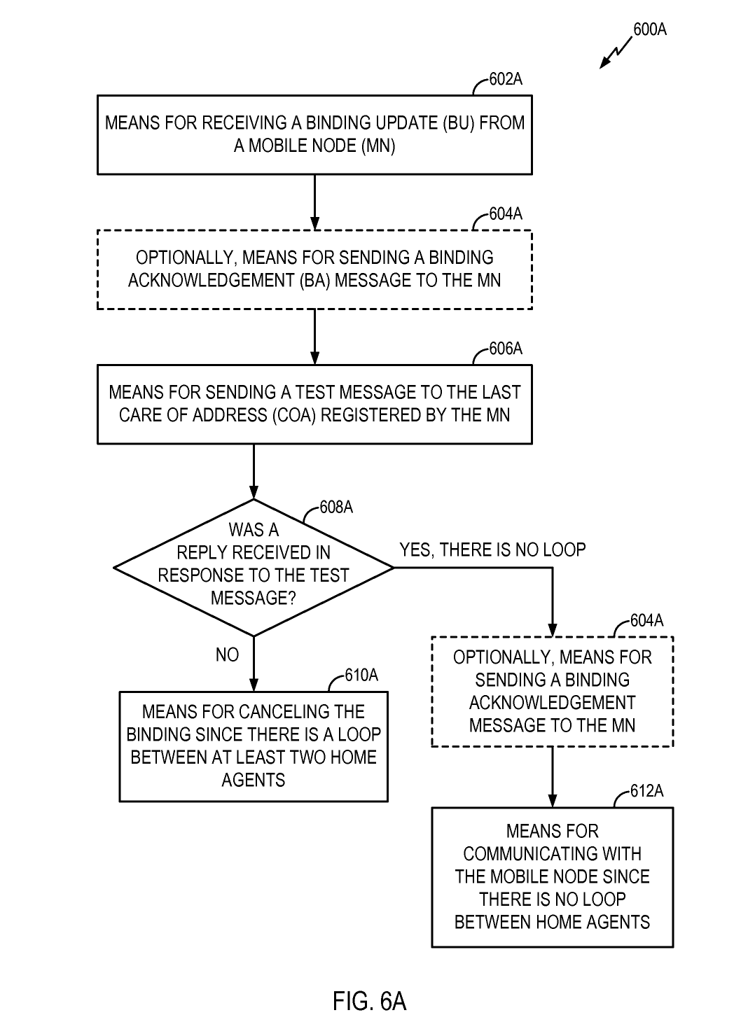

FIG. 6 illustrates example operations 600 for a technique to detect a routing loop between home agents, in accordance with certain aspects of the present disclosure. At 602, a home agent receives a binding update message from a mobile node. At 604, the home agent may optionally send a binding acknowledgement (BA) message to the MN. At 606, the home agent sends a test message to the last CoA registered by the MN. At 608, if a reply was received in response to the test message, the HA declares that there is no loop and may optionally send a binding acknowledgement message to the mobile node. At 612, the home agent may continue communicating with the mobile node since there is no loop between home agents. At 610, if a reply is not received in response to the test message, the home agent cancels the binding between the MN and the home agent to break the loop.

Certain aspects of the present disclosure provide an alternate technique for detecting the routing loop between two home agents based on a procedure performed by a home agent. The HA, as part of normal operations under the MIPv6 standard, intercepts packets to any HoA assigned by itself and tunnels them to an appropriate CoA. Before tunneling a packet, the HA may check the packet to see if the packet was previously tunneled or not. If the next header is also an IP, it means that the packet was tunneled before reaching the home agent. If the packet is previously tunneled, the HA may look inside the packet and check the source address of the inner header. If the source address of the inner header matches the address of the home agent, the home agent declares finding a loop. A loop is formed when a packet initiated from a home agent is received by the same home agent at a later time.

It should be noted that the above technique detects a loop between two HAs. However, for certain aspects of the present disclosure, if an MN has created a chained loop between a plurality of home agents, the HA may continue parsing headers as long as the next header indicates encapsulation and check the source addresses of the inner headers to see if any of them matches the address of the home agent.

The above technique always detects a loop after the first packet in the loop makes a full circle as long as the tunneling technique used is easily detectable, such as the tunneling technique in the MIPv6 standard.

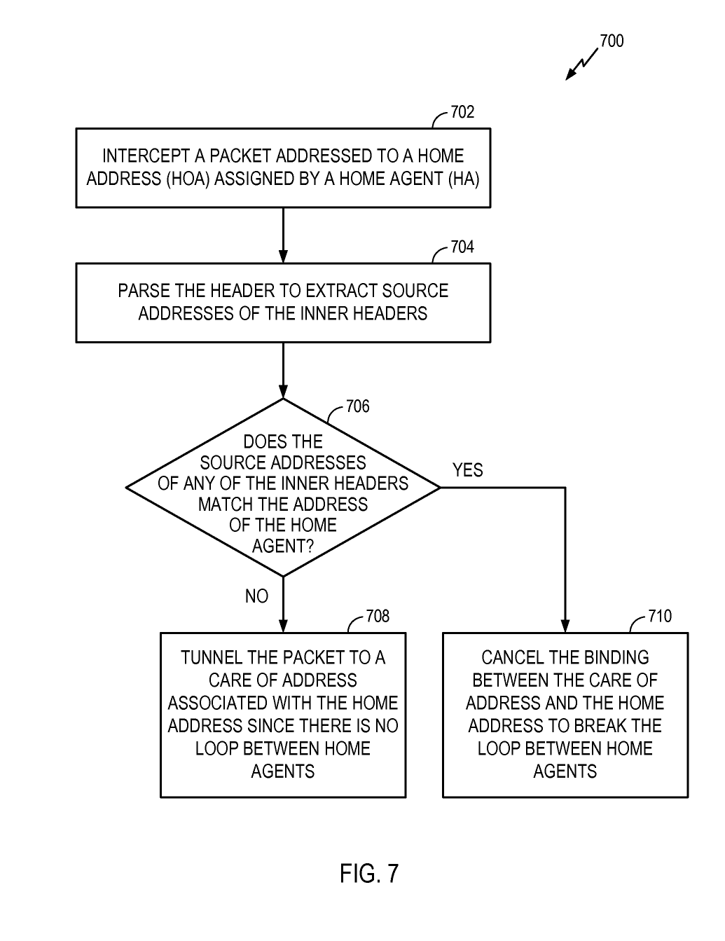

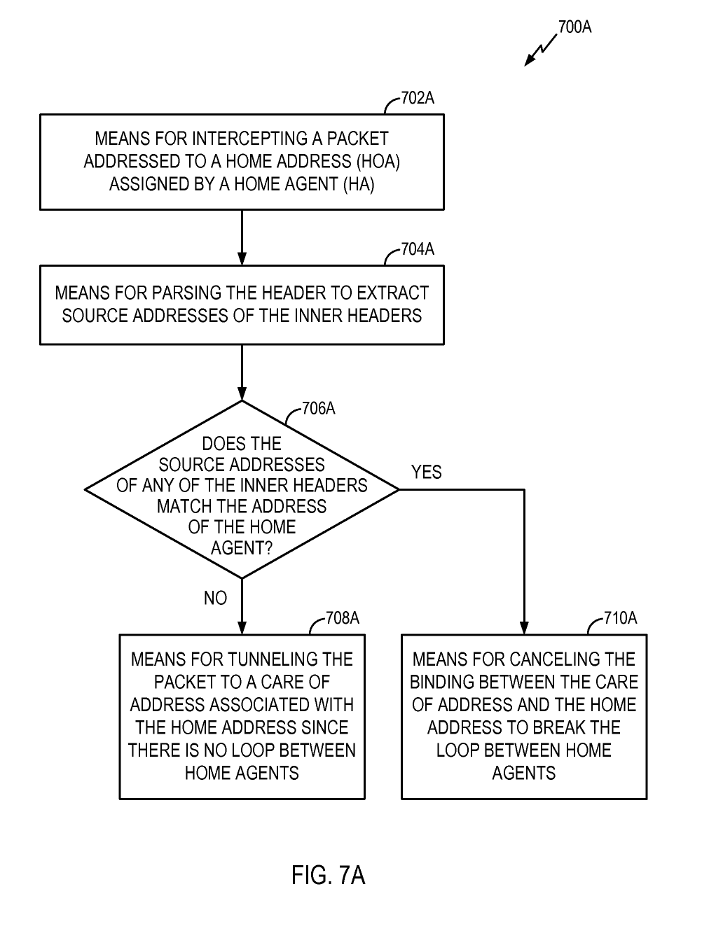

FIG. 7 illustrates example operations 700 for the alternate technique to detect a routing loop between home agents, in accordance with certain aspects of the present disclosure. At 702, a home agent intercepts a packet addressed to a home address (HoA) assigned by the home agent. The home agent determines if the packet is previously tunneled. At 704, the home agent parses the header to extract one or more source addresses of at least one inner header if the packet is previously tunneled. At 706, the home agent checks if the source address of any of the at least one inner headers matches the address of the home agent. At 708, the home agent tunnels the packet to a care of address associated with the home address if none of the one or more source addresses matches an address of the home agent. At 710, the home agent cancels the binding between the care of address and the home address to break the loop between home agents.

The various operations of methods described above may be performed by various hardware and/or software component(s) and/or module(s) corresponding to means-plus-function blocks illustrated in the Figures. For example, blocks 602-612 illustrated in FIG. 6 correspond to means-plus-function blocks 602A-612A illustrated in FIG. 6A. In addition, blocks 702-710 illustrated in FIG. 7 correspond to means-plus-function blocks 702A-710A illustrated in FIG. 7A. More generally, where there are methods illustrated in Figures having corresponding counterpart means-plus-function Figures, the operation blocks correspond to means-plus-function blocks with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

1. A method for wireless communications by a home agent, comprising:
receiving a binding update message (BU) from a mobile node,
sending a test message to the last Care-of-Address (CoA) registered by the mobile node, and
receiving a reply from the mobile node in response to the test message, wherein the reply is received if there is no routing loop between the home agent and at least one other home agent.

2. The method of claim 1, further comprising:
cancelling the binding between the mobile node and the home agent if no reply is received to the test message from the mobile node.

3. The method of claim 1, wherein the test message comprises a Care of Address Test Initiation (CoTI) message and the reply in response to the test message comprises a Care-of Address Test (CoT) message.

4. The method of claim 1, wherein a binding acknowledgement message is transmitted to the mobile node either after receiving the binding update message or after receiving the reply from the mobile node in response to the test message.

5. A method for wireless communications by a home agent, comprising:
intercepting a packet addressed to a home address (HoA),
determining if the packet is previously tunneled,
parsing a header of the packet to extract one or more source addresses of at least one inner header if the packet is previously tunneled, and
tunneling the packet to a care of address associated with the home address if none of the one or more source addresses matches an address of the home agent.

6. The method of claim 5, further comprising:
cancelling the binding of the care of address with the home address if the source address of any of the inner headers match the address of the home agent to break a routing loop.

7. An apparatus for wireless communications by a home agent, comprising:
logic for receiving a binding update message (BU) from a mobile node,
logic for sending a test message to the last Care-of-Address (CoA) registered by the mobile node, and
logic for receiving a reply from the mobile node in response to the test message, wherein the reply is received if there is no routing loop between the home agent and at least one other home agent.

8. The apparatus of claim 7, further comprising:
logic for cancelling the binding between the mobile node and the home agent if no reply is received to the test message from the mobile node.

9. The apparatus of claim 7, wherein the test message comprises a Care of Address Test Initiation (CoTI) message and the reply in response to the test message comprises a Care-of Address Test (CoT) message.

10. The apparatus of claim 7, wherein a binding acknowledgement message is transmitted to the mobile node either after receiving the binding update message or after receiving the reply from the mobile node in response to the test message.

11. An apparatus for wireless communications by a home agent, comprising:
logic for intercepting a packet addressed to a home address (HoA),
logic for determining if the packet is previously tunneled,
logic for parsing a header of the packet to extract one or more source addresses of at least one inner header if the packet is previously tunneled, and
logic for tunneling the packet to a care of address associated with the home address if none of the one or more source addresses matches an address of the home agent.

12. The apparatus of claim 11, further comprising:
logic for cancelling the binding of the care of address with the home address if the source address of any of the inner headers match the address of the home agent to break a routing loop.

13. An apparatus for wireless communications by a home agent, comprising:
means for receiving a binding update message (BU) from a mobile node,
means for sending a test message to the last Care-of-Address (CoA) registered by the mobile node, and
means for receiving a reply from the mobile node in response to the test message, wherein the reply is received if there is no routing loop between the home agent and at least one other home agent.

14. An apparatus for wireless communications by a home agent, comprising:
means for intercepting a packet addressed to a home address (HoA),
means for determining if the packet is previously tunneled,
means for parsing a header of the packet to extract one or more source addresses of at least one inner header if the packet is previously tunneled, and
means for tunneling the packet to a care of address associated with the home address if none of the one or more source addresses matches an address of the home agent.

15. A computer-program product for wireless communications by a home agent, comprising a computer readable medium having instructions stored thereon, the instructions being executable by one or more processors and the instructions comprising:
instructions for receiving a binding update message (BU) from a mobile node,
instructions for sending a test message to the last Care-of-Address (CoA) registered by the mobile node, and
instructions for receiving a reply from the mobile node in response to the test message, wherein the reply is received if there is no routing loop between the home agent and at least one other home agent.

16. A computer-program product for wireless communications by a home agent, comprising a computer readable medium having instructions stored thereon, the instructions being executable by one or more processors and the instructions comprising:
instructions for intercepting a packet addressed to a home address (HoA),
instructions for determining if the packet is previously tunneled,
instructions for parsing a header of the packet to extract one or more source addresses of at least one inner header if the packet is previously tunneled, and
instructions for tunneling the packet to a care of address associated with the home address if none of the one or more source addresses matches an address of the home agent.

17. An apparatus for wireless communications by a home agent, comprising at least one processor configured to:
receive a binding update message (BU) from a mobile node,
send a test message to the last Care-of-Address (CoA) registered by the mobile node, and
receive a reply from the mobile node in response to the test message, wherein the reply is received if there is no routing loop between the home agent and at least one other home agent.

18. An apparatus for wireless communications by a home agent, comprising at least one processor configured to:
intercept a packet addressed to a home address (HoA),
determine if the packet is previously tunneled,
parse a header of the packet to extract one or more source addresses of at least one inner header if the packet is previously tunneled, and
tunnel the packet to a care of address associated with the home address if none of the one or more source addresses matches an address of the home agent.
